(19) United States
(12) Patent Application Publication
(10) Pub. No.: US 2006/0034230 A1
(43) Pub. Date: Feb. 16, 2006

(54) Telecommunication device

(75) Inventors: Thomas Wellhausen, Berlin (DE); Ivo Gadow, Berlin (DE)

Correspondence Address: LERNER AND GREENBERG, PA, P O BOX 2480, HOLLYWOOD, FL, 33022-2480, US

(73) Assignee: DeTeWe Systems GmbH

(21) Appl. No.: 11/242,582

(22) Filed: Oct. 3, 2005

(30) Foreign Application Priority Data
Mar. 3, 2004 (DE) 102004010991.5-31

(51) Int. Cl. H04B 7/216

(52) U.S. Cl. 370/335; 370/493

(57) ABSTRACT

A communications device provides connections for a speech data transfer and digital data transfer between digital telecommunications terminals, analog telecommunications terminals and data processing appliances. The communications device includes an xDSL terminal adapter for autonomously setting up and clearing connections in a public telecommunications network as well as on the Internet. The xDSL terminal adapter has an xDSL modem connected to an xDSL data line or to a broadband connection, an ISDN signal converter connected to the xDSL modem and having at least one S₀ connection for ISDN terminals, and an analog signal converter connected to the xDSL modem and having at least one a/b connection for analog terminals.

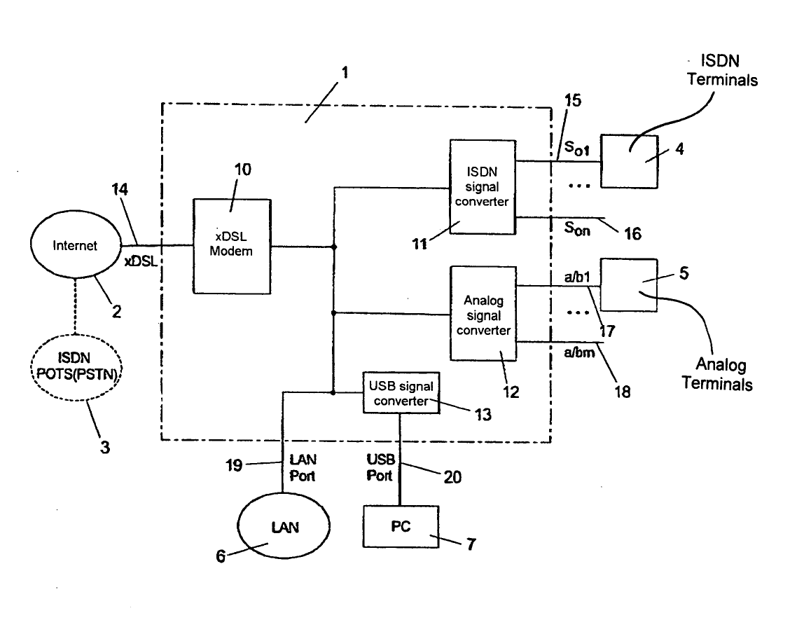

### BACKGROUND OF THE INVENTION

### FIELD OF THE INVENTION

The invention relates to a telecommunications device for providing connections for a speech transfer and digital data transfer between digital telecommunications terminals, analog telecommunications terminals and data processing appliances.

In the case of communication using signal lines, as is normal nowadays, one problem that arises is that different transmission methods and transmission protocols are used. PSTN (Public Switch Telephone Network) lines of a POTS (Plain Old Telephone Service) are therefore used for signal transmission with analog signals, through which speech messages, fax signals or else digital files are interchanged between terminals such as telephones, fax machines or computers. Modems are used for conversion of the analog signals, such as audio frequency signals on the telephone line, to digital signals, such as binary signals for a computer, or from digital signals to analog signals.

Analog signal transmission is suitable only to a restricted extent for the present-day requirements of the amounts of data to be transmitted. Digital transmission methods and transmission protocols such as ISDN, xDSL or ATM systems are used for signal transmission for this reason. ISDN is short for Integrated Service Digital Network, xDSL is a general expression for high-speed DSL (Digital Subscriber Line) in which x is denoted by A for an Asynchronous DSL transmission technique (ADSL), S for a Synchronous DSL transmission technique (SDSL), VDSL, etc., and ATM (Asynchronous Transfer Mode) systems are a wide-bandwidth digital method. Transmission speeds of up to 10 Mbit/s can be achieved by DSL transmission. If xDSL transmission is used at the same time as a public communications network, then the public communications network is used in a lower frequency band, and xDSL transmission is used in a frequency band above that, which necessitates a splitter both at the subscriber end and at the network end, through the use of which the two frequency bands are separated.

In order to achieve the high data rates, ISDN and xDSL services require special communications devices with ISDN connection adapters. In that case, a transmitting ISDN connection adapter forms digital values into packets or frames with digital information, and sends those packets using a digital transmission scheme which ensures that the serial data stream is supplied reliably. A receiving ISDN connection adapter carries out the opposite function, that is to say extraction of digital values from received packets with digital information.

German Published, Non-Prosecuted Patent Application DE 100 39 402 A1, corresponding to Patent Abstracts of Japan Publication No. 2001 103 155 A, discloses a method for provision of Internet telephony services between telephones using terminal adapters in the public telephone network, such as PSTN terminal adapters or ISDN terminal adapters (Integrated Services Digital Network). The terminal adapters for the Internet telephony system in that case are constructed in such a way that, on one hand, they form an interface between one of the telephones and the Internet so that the associated telephone can carry out speech communication through the Internet and, on the other hand, data transmissions and network services can be provided for a number of computers.

German Published, Non-Prosecuted Patent Application DE 196 48 627 A1 discloses a communications system through the use of which continuous or packet-oriented data is selectively connected to a public telecommunications network through a network access unit, which is in a fixed position at the user end, and with equal priority to communications terminals such as telephones, fax machines and data terminals such as modems or computers. An IP address makes the network access unit a component of the Internet and allows it to be controlled by the data terminals through the Internet Protocol. At the subscriber end, the network access unit has at least two interfaces for conventional telephones, one interface for data terminals and one interface to the telecommunications network, which operates on a cell-oriented basis.

### SUMMARY OF THE INVENTION

It is accordingly an object of the invention to provide a telecommunications device for an xDSL or broadband connection, which overcomes the hereinafore-mentioned disadvantages of the heretofore-known devices of this general type and through the use of which analog and/or digital terminals can communicate through the Internet both in the public telecommunications network and on the Internet and internally.

With the foregoing and other objects in view there is provided, in accordance with the invention, a communications device for provding connections for a speech data transfer and digital data transfer between digital telecommunications terminals, analog telecommunications terminals and data processing appliances. The communications device comprises an xDSL terminal adapter for autonomously setting up and clearing connections both in a public telecommunications network as well as on the Internet. The xDSL terminal adapter includes an xDSL modem connected to an xDSL data line or to a broadband connection, an ISDN signal converter being connected to the xDSL modem and having at least one S₀ bus connection for ISDN terminals, and an analog signal converter being connected to the xDSL modem and having at least one a/b connection for analog terminals.

The structure according to the invention provides a communications device for an xDSL or broadband connection, through the use of which analog and/or digital terminals can communicate through the Internet both in the public telecommunications network and on the Internet and internally.

The xDSL terminal adapter thus on one hand represents an interface between the analog and/or ISDN terminals and the xDSL connection and converts, inter alia, analog to digital signals and, conversely, digital signals to analog signals. This allows analog and/or ISDN terminals to make telephone calls through the Internet using the data channel, that is to say to make and receive calls, so that not only is pure Internet telephony possible, but it is also possible to make telephone calls in the public telecommunications network.

The access of the xDSL terminal adapter to the Internet is provided selectively through the use of the xDSL connection or a broadband connection. In this case, the telephone channel, for example, is not used for ADSL, or the xDSL terminal adapter is connected downstream from a splitter, that is to say at the data interface of the splitter which is used for separation into the ADSL and the telephone or ISDN signal and, in the case of ADSL, is used with simultaneous telephone use on one line using different frequency ranges.

The xDSL connection of the xDSL terminal adapter can be connected in a corresponding manner to the data interface of a splitter which separates an ADSL signal from a telephone or ISDN signal.

The xDSL modem which is integrated in the xDSL terminal adapter in this case forms a signal converter, which converts the frequencies on the telephone line in such a way that the appliances which are located in the network can communicate with the Internet. The analog signal converter is used to convert analog signals based on xDSL, including the associated protocol structure, in order to ensure that the analog terminals which are connected through a/b interfaces to the xDSL terminal adapter can communicate with the network, and thus become components of the network. The ISDN signal converter is used to convert ISDN signals based on xDSL, including the protocol structure, so that the ISDN terminals can be connected directly to the xDSL terminal adapter through the S₀ interface.

In accordance with another feature of the invention, the xDSL terminal adapter preferably provides a parallel speech data transfer to a plurality of analog and/or digital telecommunications terminals as well as a digital data transfer in parallel to one or more speech data transfers, so that a plurality of telephone calls can be made simultaneously using the analog and/or ISDN terminals, and data transmission, for example from a personal computer, can be carried out at the same time as one or more telephone calls.

In accordance with a further feature of the invention, the xDSL terminal adapter has a LAN port which is connected to a local area network, and a USB port, which is connected to the xDSL modem through a USB signal converter. The local area network (LAN) can be configured as desired and may use any desired transmission speed, that is to say for example it may be in the form of an HSLAN (High-Speed LAN). The LAN transmission and access method that is used is also undefined and may, for example, include CSMA/CD (Carrier Sense Multiple Access/With Collision Detection), as is defined in IEEE Standard 802.3, in particular the Ethernet, FDDI (Fiber Distributed Data Interface), DQDB (Distributed Queue Dual Bus) or the like.

In accordance with an added feature of the invention, in consequence, irrespective of the operation of the analog and/or ISDN appliances, a personal computer, for example, is connected to the Internet by xDSL and through the USB and/or LAN interface provided in the xDSL terminal adapter.

For configuration of the xDSL terminal adapter, a personal computer can be connected to the xDSL terminal adapter through the LAN port or the USB port.

In accordance with an additional feature of the invention, the switching functions can be carried out through the use of private branch exchange telephones, autonomously from the xDSL.

In accordance with a concomitant feature of the invention, there is provided not only a switching function for calls arriving through the xDSL connection and for passing them on to the ISDN terminals or analog terminals, but also internal communication between the ISDN terminals and the analog terminals, as well as between the ISDN terminals and the analog terminals without inclusion of the xDSL modem, as well as a digital data transfer between a plurality of computers which are connected to the xDSL terminal adapter.

Other features which are considered as characteristic for the invention are set forth in the appended claims.

Although the invention is illustrated and described herein as embodied in a telecommunications device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCIPTION OF THE DRAWINGS

The figure of the drawing is a block diagram with which the construction and operation of an xDSL terminal adapter according to the invention will be explained in more detail.

### DESCRIPTION OF THE PREFERRED EMBODIMENTS

Referring now in detail to the single figure of the drawings, there is seen an xDSL terminal adapter 1 according to the invention which contains an xDSL modem 10 that is connected to the Internet 2 through an xDSL connection 14. A public telecommunications network 3 in the form of an ISDN, POTS or PSTN network is accessed directly or through a service provider.

The xDSL modem 10 is connected to an ISDN signal converter 11 which has a total number of n S₀₁ to S₀ₙ interfaces 15, 16, to which ISDN terminals 4 can be connected, where n is an integer greater than or equal to 1. The ISDN signal converter 11 converts the ISDN signals based on xDSL, including the protocol structure, in such a way that the ISDN terminals 4 can make telephone calls both on the Internet 2 and on the public telephone network 3 over the Internet 2, which is accessed through the use of xDSL or a broadband connection, using the data channel.

The xDSL modem 10 is also connected to an analog signal converter 12, which provides a total number of m a/b interfaces a/b₁ to a/bₘ 17, 18 for analog terminals 5, where m is an integer greater than or equal to 1 and need not necessarily be equal to the total number n of S₀ interfaces 15, 16. The analog signal converter 12 converts analog signals based on xDSL including the associated protocol structure, in such a way that the analog terminals 5 can make telephone calls to the Internet 2 using the data channel, that is to say they can make and receive calls, likewise through xDSL or a broadband connection, through the total number of m a/b interfaces 17, 18.

The xDSL terminal adapter 1 can be connected to a personal computer and/or to a local area network 6 through a LAN port 19. A personal computer 7 can be connected to the xDSL modem 10 through a USB port 20 and a USB signal converter 13, so that the xDSL terminal adapter 1 can be configured through the use of the personal computer 7 or a computer in the local area network 6, with the operating system of the computer that is used not being defined.

Since the xDSL terminal adapter 1 can very largely carry out the task and function of a telecommunications exchange by virtue of its internal structure, switching functions are also possible for incoming calls through the xDSL connection 14. These calls are passed on to the ISDN terminals 4 and to the analog terminals 5. Internal communication between the ISDN terminals 4 and the analog terminals 5 is also possible, as well as communication between the ISDN terminals 4 and analog terminals 5 without inclusion of the xDSL modem 10, using the xDSL terminal adapter 1.

Furthermore, a digital data transfer, for example, is also possible between a PC 7 which is connected to the USB port 20 and one or more computers which are connected to the xDSL terminal adapter 1 through the LAN port 19, in the local area network 6, at the same time as a plurality of telephone calls.

We claim:

1. A communications device for provding connections for a speech data transfer and digital data transfer between digital telecommunications terminals, analog telecommunications terminals and data processing appliances, the communications device comprising:
an xDSL terminal adapter for autonomously setting up and clearing connections both in a public telecommunications network as well as on the Internet, said xDSL terminal adapter including:
an xDSL modem connected to an xDSL data line or to a broadband connection;
an ISDN signal converter being connected to said xDSL modem and having at least one S₀ connection for ISDN terminals; and
an analog signal converter being connected to said xDSL modem and having at least one a/b connection for analog terminals.

2. The communications device according to claim 1, wherein said xDSL terminal adapter provides a parallel speech data transfer to a plurality of analog and/or digital telecommunications terminals.

3. The communications device according to claim 1, wherein said xDSL terminal adapter provides a digital data transfer in parallel to one or more speech data transfers.

4. The communications device according to claim 1, wherein said xDSL terminal adapter has a LAN port connected to a local area network.

5. The communications device according to claim 1, wherein said xDSL terminal adapter has a USB port connected through a USB signal converter to said xDSL modem.

6. The communications device according to claim 4, wherein said xDSL terminal adapter is connected through said LAN port to a personal computer for configuration of said xDSL terminal adapter.

7. The communications device according to claim 5, wherein said xDSL terminal adapter is connected through said USB port to a personal computer for configuration of said xDSL terminal adapter.

8. The communications device according to claim 1, which further comprises:
a switching function for calls arriving through said xDSL connection and for passing the calls on to the ISDN terminals or analog terminals;
an internal communication between the ISDN terminals and the analog terminals; and
a communication between the ISDN terminals and the analog terminals without inclusion of said xDSL modem.

9. The communications device according to claim 1, which further comprises:
a LAN port of said xDSL terminal adapter connected to a local area network;
a USB port of said xDSL terminal adapter connected through a USB signal converter to said xDSL modem; and
a digital data transfer between a personal computer connected to said USB port and one or more computers disposed in the local area network and connected to said xDSL terminal adapter through said LAN port.

10. The communications device according to claim 1, wherein said xDSL connection of said xDSL terminal adapter is connected to a data interface of a splitter separating an ADSL signal from a telephone or ISDN signal.
